(19) United States
(12) Patent Application Publication
(10) Pub. No.: US 2011/0080606 A1
(43) Pub. Date: Apr. 7, 2011

(54) PRINTING APPARATUS, PRINTING METHOD, AND PRINTING PROGRAM

(75) Inventor: Atsuhiko EGUCHI, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 12/897,764

(22) Filed: Oct. 4, 2010

Related U.S. Application Data
(60) Provisional application No. 61/248,945, filed on Oct. 6, 2009.

(51) Int. Cl. G06F 15/00

(52) U.S. Cl. 358/1.13

(57) ABSTRACT

According to an embodiment, a printing apparatus includes: an image reading unit configured to optically read an original document; a setting unit configured to set a printing mode; and a controller configured to execute, on the basis of the printing mode set by the setting unit, a multi mode for continuously printing image data of the original document read by the image reading unit in a first printing mode and a second printing mode different from the first printing mode.

### CROSS-REFERENCE TO RELATED APPLICATION

This application is also based upon and claims the benefit of priority from U.S. provisional application 61/248,945, filed on Oct. 6, 2009; the entire contents of which are incorporated herein by reference.

### FIELD

Embodiments described herein relate generally to a technique for a printing apparatus.

### BACKGROUND

In a printing apparatus in the past, when a user executes plural jobs in different printing modes, the user has to execute the printing modes separately from one another. For example, when the user prints one print data in two different printing modes including normal copying and N-in-1, the user needs to set an original document in each of the printing modes and perform reading work.

Since work from the setting of the original document to the reading work is redundant, a work time is extended and a power loss increases.

### DESCRIPTION OF THE DRAWINGS

FIG. 1 is a sectional view of a printing apparatus;

FIG. 2 is a flowchart for explaining a setting procedure for a printing mode;

FIG. 3 is a diagram of a user interface (UI) of a display screen of a setting unit;

FIG. 4 is diagram of a UI of a display screen of the setting unit after multi job selection; and

FIG. 5 is a flowchart for explaining a setting procedure for a printing mode of a modification.

### DETAILED DESCRIPTION

In general, according to an embodiment, a printing apparatus includes: an image reading unit configured to optically read an original document; a setting unit configured to set a printing mode; and a controller configured to execute, on the basis of the printing mode set by the setting unit, a multi mode for continuously printing image data of the original document read by the image reading unit in a first printing mode and a second printing mode different from the first printing mode.

“Continuously” means that it is unnecessary to read the same original document again. Image data of an original document read once is used in both the first and second printing modes.

Embodiments are explained below.

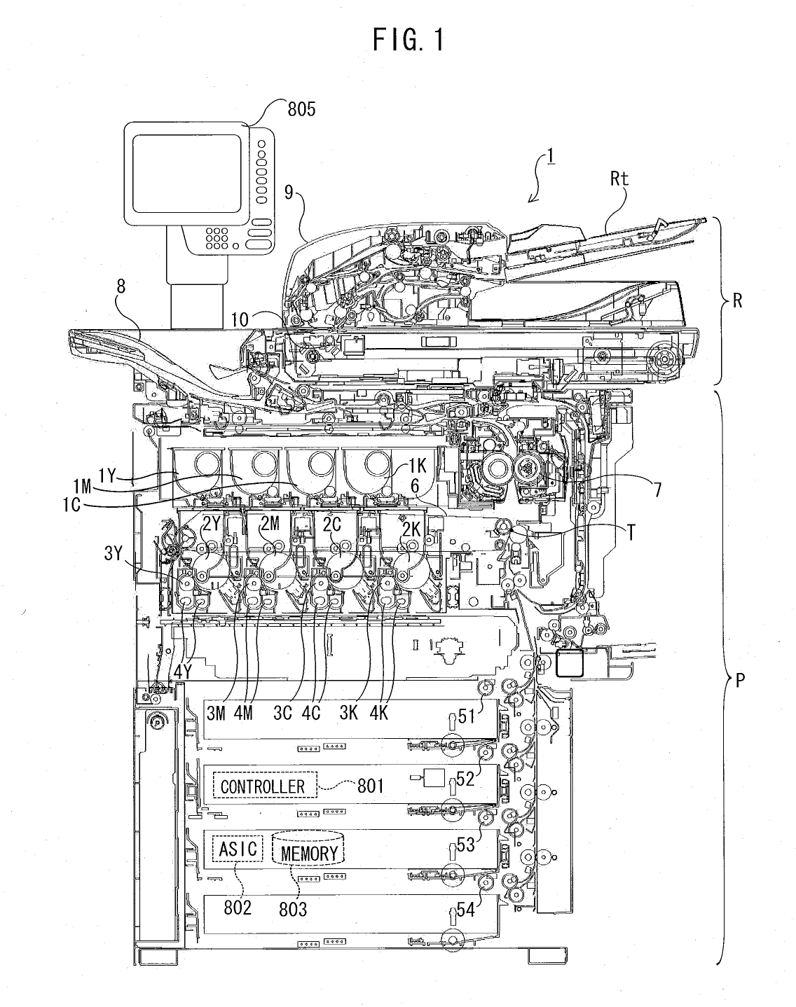

FIG. 1 is a sectional view of a printing apparatus. An X axis, a Y axis, and a Z axis indicate three different axes orthogonal to one another.

Referring to FIG. 1, a printing apparatus 1 includes an image reading unit R and an image forming unit P. The image reading unit R has a function of scanning and reading images of a sheet original document and a book original document.

The image forming unit P has a function of forming a developer image on a sheet on the basis of, for example, an image read from an original document by the image reading unit R or a print data transmitted from an external apparatus to the printing apparatus 1.

The image reading unit R includes an auto document feeder (ADF) 9 configured to automatically convey an original document to a predetermined image reading position. The image reading unit R reads, with a scanning optical system 10, an image of an original document automatically conveyed by the auto document feeder 9 and placed on a document tray Rt or an original document placed on a not-shown document table.

The image forming unit P includes toner cartridges 1Y to 1K, pickup rollers 51 to 54, photoconductive members 2Y to 2K, developing rollers 3Y to 3K, mixers 4Y to 4K, an intermediate transfer belt 6, a fixing device 7, and a discharge tray 8.

The printing apparatus 1 according to this embodiment further includes a controller 801, an ASIC 802, a memory 803, and a setting unit 805.

The controller 801 has a role of performing various kinds of processing in the printing apparatus 1. The controller 801 also has a role of realizing various functions by executing computer programs stored in the memory 803. The memory 803 may be, for example, a RAM (Random Access Memory), a ROM (Read Only Memory), a DRAM (Dynamic Random Access Memory), an SRAM (Static Random Access Memory), or a VRAM (Video RAM). The memory 803 has a role of storing various kinds of information and computer programs used in the printing apparatus 1.

Various kinds of setting are displayed on the setting unit 805. The setting unit 805 may be a touch panel type. The various kinds of setting include print setting.

The print setting means a printing method that can be changed according to preference of a user. The print setting includes monochrome printing, digest copy, N-in-1, and color printing. The digest copy is a printing format for automatically reducing plural original documents and displaying the original documents on one sheet side by side.

An example of an overview of copy processing by the printing apparatus 1 is explained below.

When printing is started, first, the pickup rollers 51 to 54 pick up sheets from cassettes. The picked-up sheets move along a sheet conveying path while being guided by plural roller pairs.

The scanning optical system 10 reads, in the predetermined image reading position, an image of a sheet original document automatically conveyed by the auto document feeder 9.

Subsequently, the image forming unit P forms electrostatic latent images on photoconductive surfaces of the photoconductive members 2Y, 2M, 2C, and 2K on the basis of print data of the image read from the original document by the image reading unit R.

The developing rollers 3Y to 3K supply developers agitated by the mixers 4Y to 4K of a developing device to the photoconductive members 2Y to 2K having the electrostatic latent images. Consequently, the electrostatic latent images formed on the photoconductive surfaces of the photoconductive members 2Y to 2K are visualized.

Developer images formed on the photoconductive members 2Y to 2K in this way are transferred onto a belt surface of the intermediate transfer belt 6 (so-called primary transfer). The developer images conveyed by the rotation of the intermediate transfer belt 6 are transferred onto the sheets in a predetermined secondary transfer position T.

The fixing device 7 heats and fixes the developer images, which are transferred onto the sheets, on the sheets. The sheets having the developer images heated and fixed thereon are conveyed through a conveying path by plural conveying rollers and sequentially discharged onto the discharge tray 8.

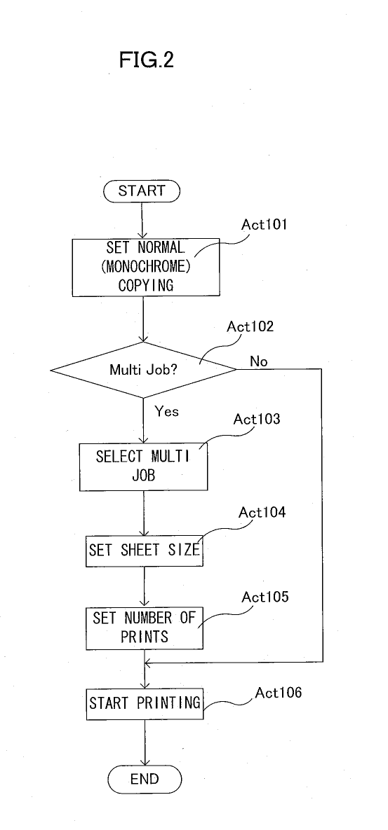

A print setting method for the printing apparatus is explained with reference to a flowchart of FIG. 2. The user performs print setting by operating the setting unit 805.

In Act 101, the user operates the setting unit 805 to thereby perform setting for normal copying, i.e., monochrome printing. After the setting for the monochrome printing, the user may operate the setting unit 805 to thereby perform setting of a sheet size and setting of the number of prints.

If the user desires multi printing in Act 102, the user proceeds to Act 103.

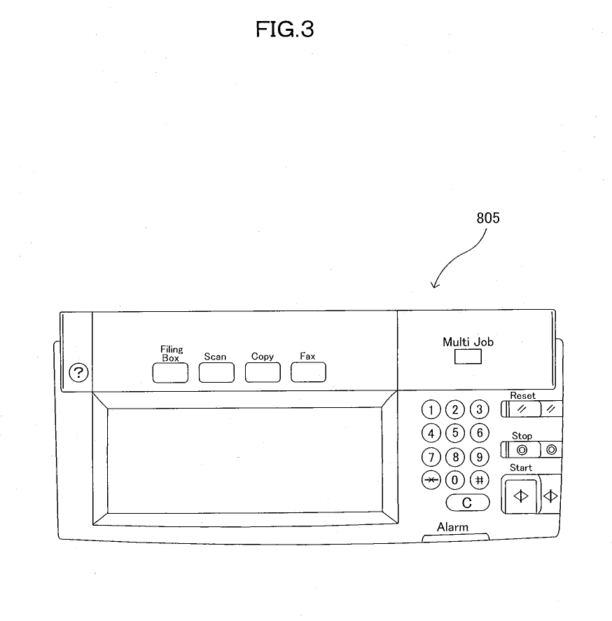

In Act 103, the user operates the setting unit 805 to thereby select “Multi Job”. FIG. 3 is a diagram of a display screen of the setting unit 805 in selecting “Multi Job”. The user presses a “Multi Job” button displayed at the upper right of the display screen of the setting unit 805 to thereby select the multi printing.

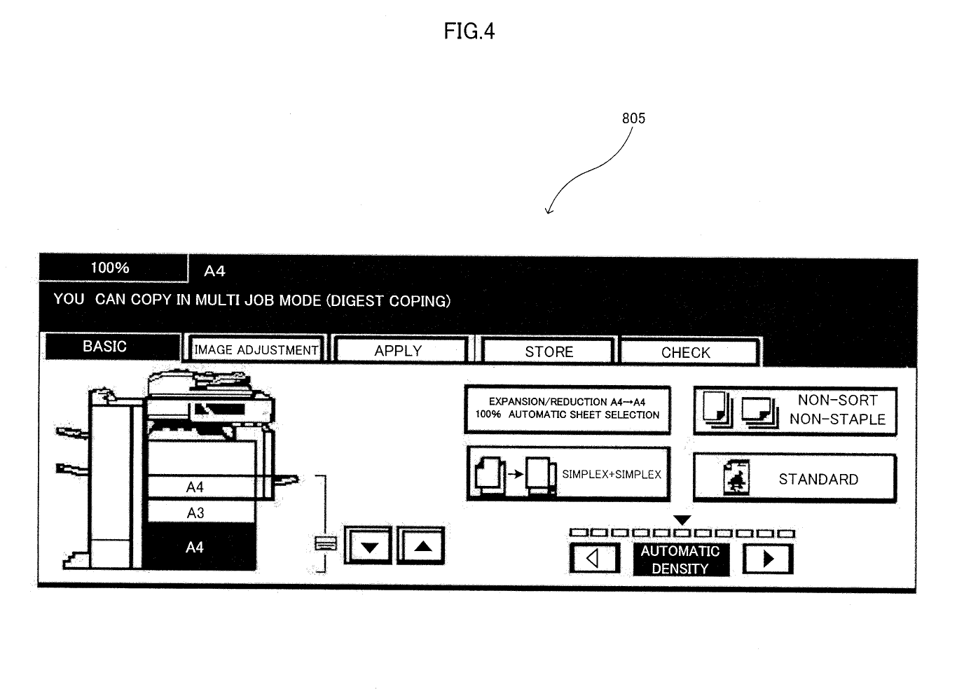

When the user selects the multi printing in Act 103, the display of the setting unit 805 is switched to display shown in FIG. 4. Information concerning content of the multi printing, i.e., characters “you can copy in multi job mode (digest copying)” are displayed. In this embodiment, the monochrome printing and the digest copying are set in advance as the multi printing.

When “Multi Job” is selected, the monochrome printing as the first printing mode and the digest copying as the second copying mode are continuously executed. The order of execution may be opposite.

In Act 104, the user operates the setting unit 805 to thereby set a sheet size. In Act 105, the user operates the setting unit 805 to thereby set the number of prints. In Act 106, the user operates the setting unit 805 to thereby start printing.

If the user does not desire the multi printing in Act 102, the user proceeds to Act 106 and starts printing.

When the monochrome printing as the first printing mode is completed, the controller 801 immediately executes the digest copying as the second printing mode.

Before performing the digest copying, the user does not have to set the original document on the document tray Rt again. Therefore, labor and time of the user are reduced.

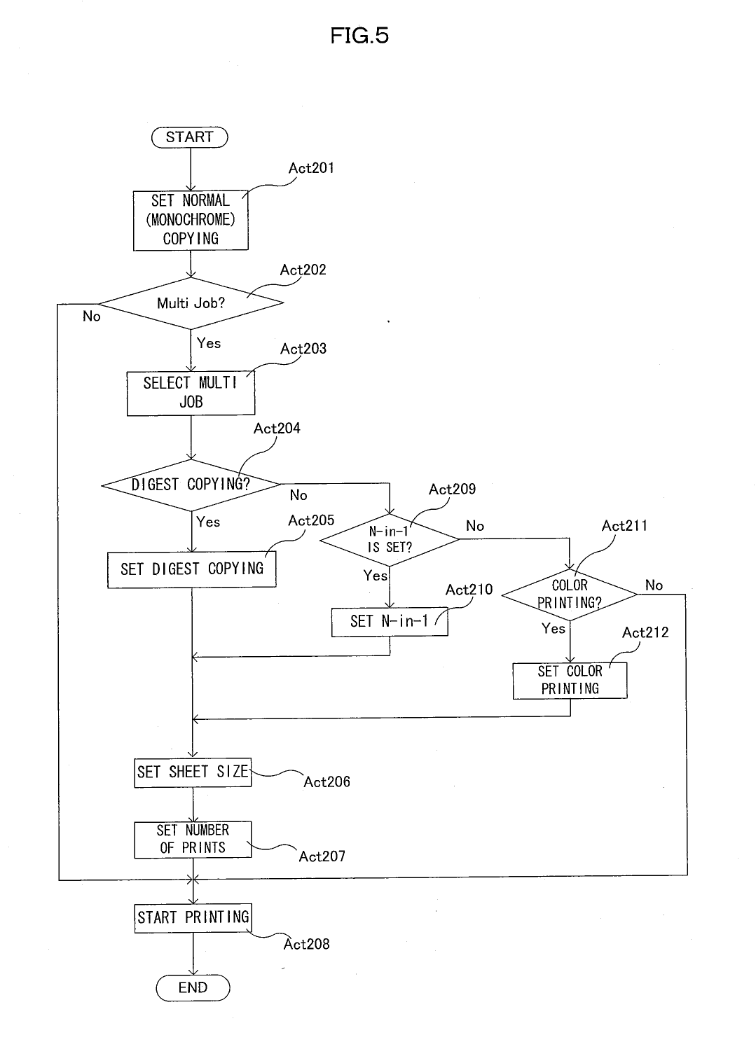

A print setting method for a printing apparatus according to another embodiment is explained with reference to a flowchart of FIG. 5. The user performs print setting by operating the setting unit 805.

In Act 201, the user operates the setting unit 805 to thereby perform setting of the normal copying, i.e., the monochrome printing. After the setting of the monochrome printing, the user may operate the setting unit 805 to thereby perform setting of a sheet size and setting of the number of prints.

If the user desires the multi printing in Act 202, the user proceeds to Act 203.

In Act 203, the user operates the setting unit 805 to thereby select “Multi Job”. FIG. 3 is a diagram of a display screen of the setting unit 805 in selecting “Multi Job”. The user presses the “Multi Job” button displayed at the upper right of the display screen of the setting unit 805 to thereby select the multi printing.

If the user desires the digest copying in Act 204, the user proceeds to Act 205 and selects the digest copying. Acts 206 to 208 are the same as Acts 104 to 106 in the embodiment explained above. Therefore, the explanation of the acts is not repeated.

If the user does not desire the digest copying in Act 204, the user proceeds to Act 209. If the user desires printing in the N-in-1 in Act 209, the user proceeds to Act 210.

In Act 210, the user operates the setting unit 805 to thereby perform setting of the N-in-1 and proceeds to Act 206. Specifically, the user operates the setting unit 805 to thereby input the number of original documents to be printed per one page.

If the user does not desire the printing in the N-in-1 in Act 209, the user proceeds to Act 211. If the user desires the color printing in Act 211, the user proceeds to Act 212.

In Act 212, the user operates the setting unit 805 to thereby perform setting for the color printing and proceeds to Act 206.

If the user desires none of the digest copying, the N-in-1 and the color printing, the user proceeds to Act 208.

The controller 801 executes a printing program stored in the memory 803 to thereby perform the multi printing.

In the example explained in this embodiment, the printing program is recorded in advance in a storage area provided on the inside of the printing apparatus 1. However, the present invention is not limited to this. The same computer program may be downloaded from a network to the printing apparatus 1 or the same computer program stored in a computer-readable recording medium may be installed in the printing apparatus 1. A form of the recording medium may be any form as long as the recording medium can store the computer program and can be read by a computer. Specifically, examples of the recording medium include internal storage devices internally mounted on the computer such as a ROM and a RAM, portable storage media such as a CD-ROM, a flexible disk, a DVD disk, a magneto-optical disk, and an IC card, a database that stores the computer program, other computers and databases thereof, and a transmission medium on a line. Functions obtained by the installation or the download in advance in this way may be realized in cooperation with an OS (operating system) in the apparatus.

The computer program may be an execution module that is dynamically generated partially or entirely.

It goes without saying that it is also possible to cause the ASIC 802 to execute, in terms of a circuit, at least apart of various kinds of processing realized by causing the controller 801 to execute the computer program in the embodiments.

Modification

In the embodiments, the combinations of the monochrome printing and the other printing modes are explained as the examples. However, other combinations are also possible. For example, a combination of the digest copying and the N-in-1 included in the other printing modes is also possible.

It is also possible to display a selection screen for the multi printing on the setting unit 805 first and, when the multi printing is selected, display all the printing modes included in the printing apparatus 1 on the setting unit 805. The user combines the plural printing modes displayed on the setting unit 805 according to preference of the user.

The present invention can be carried out in various forms without departing from the spirit or the main characteristic thereof. Therefore, the embodiments explained above are only an illustration in every aspect and should not be limitedly interpreted. The scope of the present invention is indicated by the scope of claims and is by no means limited by the text of the specification. Further, all modifications and various improvements, substitutions, and alterations belonging to the scope of equivalents of the scope of claims are within the scope of the present invention.

What is claimed is:

1. A printing apparatus comprising:
an image reading unit configured to optically read an original document;
a setting unit configured to set a printing mode; and
a controller configured to execute, on the basis of the printing mode set by the setting unit, a multi mode for continuously printing image data of the original document read by the image reading unit in a first printing mode and a second printing mode different from the first printing mode.

2. The apparatus according to claim 1, wherein the setting unit includes a selection screen for selecting the multi mode.

3. The apparatus according to claim 2, wherein the first printing mode is monochrome printing and the second printing mode is digest copying.

4. The apparatus according to claim 1, wherein
the first printing mode is set in advance, and
the setting unit includes a selection screen for selecting the second printing mode out of a plurality of the printing modes.

5. The apparatus according to claim 4, wherein
the first printing mode is monochrome printing, and
the controller displays, on the selection screen, at least digest copying, N-in-1, and color printing as selection targets of the second printing mode.

6. The apparatus according to claim 1, wherein the setting unit includes a selection screen for selecting the first and second printing modes out of a plurality of the printing modes.

7. The apparatus according to claim 6, wherein the first and second printing modes are any one of monochrome printing, digest copying, N-in-1, and color printing.

8. The apparatus according to claim 1, further comprising an automatic document conveying unit configured to automatically convey the original document to a position for reading by the image reading unit.

9. A printing method for a printing apparatus for continuously printing optically-read image data in a first printing mode and a second printing mode different from the first printing mode.

10. The method according to claim 9, wherein the printing apparatus includes a setting unit configured to set a printing mode.

11. The method according to claim 10, wherein the setting unit includes a selection screen for selecting a multi mode.

12. The method according to claim 11, wherein the first printing mode is monochrome printing and the second printing mode is digest copying.

13. The method according to claim 10, wherein
the first printing mode is set in advance, and
the setting unit includes a selection screen for selecting the second printing mode out of a plurality of the printing modes.

14. The method according to claim 13, wherein
the first printing mode is monochrome printing, and
at least digest copying, N-in-1, and color printing are displayed on the selection screen as selection targets of the second printing mode.

15. The method according to claim 10, wherein the setting unit includes a selection screen for selecting the first and second printing modes out of a plurality of the printing modes.

16. The method according to claim 15, wherein the first and second printing modes are any one of monochrome printing, digest copying, N-in-1, and color printing.

17. The method according to claim 9, wherein the printing apparatus further includes an automatic document conveying unit configured to automatically convey an original document to a position for reading by an image reading unit.

18. A printing program for causing a computer of a printing apparatus to execute continuous printing of optically-read image data in a first printing mode and a second printing mode different from the first printing mode.
